(19) United States
(12) Patent Application Publication
(10) Pub. No.: US 2009/0134977 A1
(43) Pub. Date: May 28, 2009

(54) Method and apparatus for RFID device coexistance

(75) Inventor: Anthony J. Grewe, Fogelsville, PA (US)

Correspondence Address: IP Legal Services LLC, 1500 East Lancaster Avenue, Suite 200,, P.O. Box 1027, Paoli, PA, 19301, US

(73) Assignee: Agere Systems Inc.

(21) Appl. No.: 11/998,057

(22) Filed: Nov. 28, 2007

(51) Int. Cl. H04Q 5/22

(52) U.S. Cl. 340/10.3

(57) ABSTRACT

In accordance with exemplary embodiments, a radio frequency identification (RFID) device might employ channel-in-use sensing and time multiplexing transmission to prevent radio systems of RFID devices in close proximity to one another from transmitting while another one of the RFID devices is transmitting so as to reduce, for example, radio interference at the transmitting RFID device. RFID transceivers not transmitting might employ a random back off procedure once a close proximity transmission is detected so that the RFID devices do not repetitively try to seize the channel at approximately the same time.

### BACKGROUND OF THE INVENTION

1. Field of the Invention

The present invention relates to radio communications, and, in particular, to coexistence of radio frequency identification (RFID) devices in close proximity.

2. Description of the Related Art

Radio frequency identification (RFID) devices enable an automatic identification method by storing and remotely retrieving data using transponders. RFID devices are increasingly found in many common applications, such as credit cards, passports, and inventory control tags. RFID devices generally contain at least two parts: i) an integrated circuit for storing and processing information, modulating and demodulating an RF signal and other functions, and ii) an antenna for receiving and transmitting the signal. RFID devices can be classified as passive, active, or semi-passive (also known as battery-assisted) devices depending on the method by which the device becomes active. Passive devices require no internal power source, thus being active only when a reader is nearby to power them, while semi-passive and active devices require an internal power source. To communicate, the devices respond to queries from a reader/sender device (“a reader”) by generating signals that do not create interference with the reader's signals, as arriving signals at the reader have low SNR but should be uniquely identifiable.

FIG. 1 shows an exemplary RFID system 100 of the prior art. RFID system 100 comprises four essential system components: RFID transceivers 101(a)-101(n) communicating through a wireless infrastructure or channel 102 to readers 103(a)-103(c). Each reader communicates with a host system interface, shown by example in FIG. 1 as reader 103(a) in communication with host system interface 104, where host system interface 104 might include a data validation process.

For credit card, passport, or similar applications that require secure communication between the reader and the RFID transceiver, two classifications exist: proximity cards and vicinity cards. Proximity card is a generic name for contactless integrated circuit devices used for security access or payment systems. Proximity cards have a range of 0-3 inches in most instances, allowing the user to leave the card in one's wallet, or purse. Newer 13.56 MHz contactless RFID cards, most commonly known as contactless smartcards, are covered by the ISO 14443 (Proximity Card) standard. Vicinity cards are devices that can be read from a greater distance than proximity cards, and operate at the 13.56 MHz frequency with maximum read distance of 1-1.5 metres. Vicinity cards are covered by the ISO 15693 (Vicinity Card) standard, which contains a collision avoidance mechanism for operation around other cards conforming to the ISO 15693 standard.

Because passive devices are activated by a pulse from a reader, difficulties might be encountered when several RFID devices are in close proximity in, for example, a person's wallet. When the person comes in range of a reader, the reader's trigger pulse might wake LIP more than one card. At that point, the reader i) can see multiple cards and doesn't know what steps to take and/or ii) the channel becomes unusable as multiple cards vie for the channel, effectively jamming each other. So, when the reader detects multiple contactless cards it requests the cardholder to tell the system what to do or to select a card to use.

Therefore, enabling multiple RFID devices (or “RFID tags”) located in close proximity to one another but conforming to differing standards of communication with readers leads to potential radio interference and reduced performance of the RFID devices. For example, contactless payment and data storage/transfer systems may be based on a wireless technology em bedded into some credit and debit cards, key fobs, and government documents such as passports and driver's licenses. The systems can each use different radio frequency communication technology to complete transactions between an RFID device and a terminal without the user having to physically swipe a card. It is desirable for RFID devices in multiple credit cards or in government documents located in an end-user's pocket or purse to peacefully coexist without interfering with each other's operating characteristics (the cards or documents could in fact be located literally on top of each other).

The convenience of contactless RFID transmissions presents a security dilemma, especially since these devices are embedded in products and documents for an ever widening range of applications. If one or more of the devices are programmed to become permanently inactive after a number of incorrect access attempts, then a device might “self-destruct” in order to protect the user from what the device believes to be an attempt by hackers to breach the system. Without a technique to manage these RFID device transceivers trying to near simultaneously access the radio channel, repeated unsuccessful attempts to access radio channels by the devices might cause one or more cards to become permanently inactive, rendering the devices useless. If these RFID devices omit this feature, the RFID devices and their associated system become vulnerable to hacking, as the possibility of an unlimited number of access attempts facilitates a cryptographic attack.

Since RFID devices in close proximity with one another can result in interference, past attempts to address this problem coordinate readers by time slicing. In another technique, the reader tries to “listen or hear” whether another reader is using a channel. If the reader learns that another reader operates on that channel, the reader rolls to another channel to avoid interfering with the other reader. Both of these methodologies rely on the readers to coordinate between their transmit and receive functions. However, these past attempts do not address having multiple RFID transceivers in a user's wallet or purse. Being in Such close proximity, the RFID devices can interfere with each other as well as interfere with their ability to communicate independently to the readers. This interference in communication can be so great that the devices might not be able to completely understand the information being read or written, and the reader associated with the device might misread the device's transmissions.

### SUMMARY OF THE INVENTION

In one embodiment, the present invention allows for data transmission by an energized radio-frequency identification (RFID device) by detecting whether a radio channel is busy with a transmission of one or more close proximity RFID devices; and, if the radio channel is busy, delaying transmission of data by the energized RFID device.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows an exemplary radio frequency identification (RFID) system of the prior art;

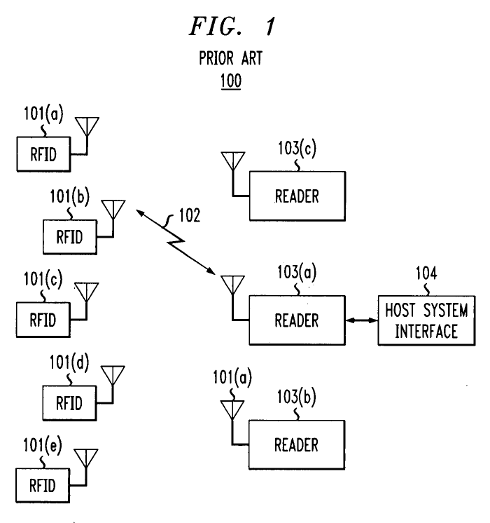

FIG. 2 shows a block diagram of an exemplary RFID device operating in accordance with one or more exemplary embodiments of the present invention; and

FIG. 3 shows an exemplary method as might be employed by the RFID device of FIG. 2.

### DETAILED DESCRIPTION

In accordance with exemplary embodiments of tie present invention, a radio frequency identification (RFID) device might employ channel-in-use sensing and time multiplexing transmission to prevent RFID devices in close proximity to one another from transmitting while another one of the RFID devices is transmitting so as to reduce, for example, radio interference at the transmitting RFID transceiver. RFID devices not transmitting might employ a random back off procedure once a close proximity transmission is detected so that, for example, the RFID devices do not repetitively try to seize the channel at approximately the same time (near simultaneously). Such technique might be easily integrated into existing radio frequency communication techniques for proximity and vicinity devices operating in accordance with differing technologies or standards (e.g., ISO 14443 (Proximity Card) standard and/or ISO 15693 (Vicinity Card) standard.

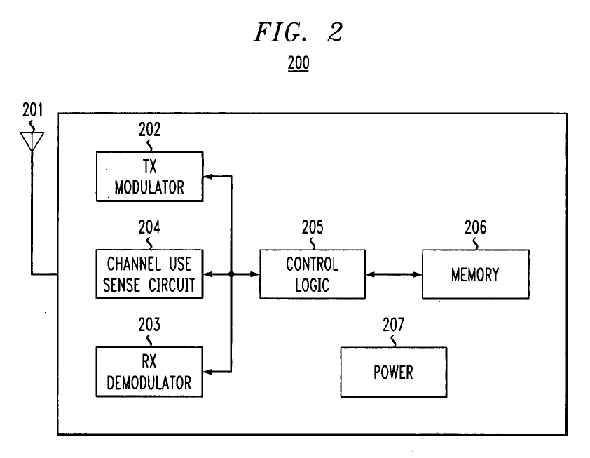

FIG. 2 shows a block diagram of an exemplary RFID device 200 operating in accordance with one or more exemplary embodiments of the present invention. RFID device 200 comprises antenna 201, transmit (TX) modulator 202, receive (RX) demodulator 203, channel-use sense circuit (CUSC) 204, control logic 205, and memory 206. Antenna 201 receives i) data transmissions (including an induced carrier frequency) from a reader (not shown in FIG. 2) and ii) radio channel energy from the wireless communication medium from other RFID devices, if transmitting. Antenna 201 also transmits data from RFID device 200. RX demodulator 203 receives modulated data as well as the radio channel energy from the wireless communication medium. TX modulator 202 modulates data from control logic 205 and provides the modulated data to antenna 201. Control logic 205 controls operation of RFID device 200, and might be implemented with a simple state machine or with a more sophisticated processor, such as an ASIC or DSP. Memory 206 stores program data and RFID device identification information used by control logic 205.

Also shown in FIG. 2 is power element 207. Power element 207 logically represents circuitry that captures energy transmitted by RFID device 200's associated reader, or by other transmitting devices, received from the radio channel at antenna 201 for a passive device. Power element 207 also represents captured energy and/or battery power in a semi-passive/active type of RFID device. Power element 207 provides power to TX modulator 202, RX demodulator 203, CUSC 204, control logic 205, and memory 206 for active operation.

As contemplated by embodiments of the present invention, each RFID device (e.g., RFID device 200, which might, as known in the art, also be termed an RFID transceiver) incorporates its own radio system (e.g., antenna 201, TX modulator 202, and RX modulator 203) and each of these radio systems operates at a similar range of frequencies with other RFID devices that are in close proximity. These RFID devices have radio systems that utilize a range of frequencies which might partially or completely overlap. Consequently, in accordance with exemplary embodiments of the present invention, one or more RFID devices in close proximity have a radio system that is controlled so that only one RFID device transfers data at any one time regardless of the particular radio system technique or standard used.

Returning to FIG. 2, RFID device 200 comprises CUSC 204 that monitors an energy level of the radio channel to determine whether one or more other RFID devices (not shown in FIG. 2) are attempting to access the radio channel. Thus, CUSC 204 provides a channel in-use sensing mechanism for RFID device 200. CUSC 204 might determine such use by measuring signal energy received at antenna 201 within specific frequency bands, declaring the radio channel “in-use” or “busy” if the measured signal energy reaches a predetermined threshold value. CUSC 204 provides information about radio channel activity to control logic 205.

RFID circuit might utilize, in addition to the channel-in-use sensing mechanism, a time multiplexing transmission scheme to prevent any of the close proximity RFID devices from transmitting while another one of the close proximity RFID devices is transmitting, since this might cause interference at the transmitting transceiver(s). The highest probability of a collision (multiple RFID devices attempting to access the radio channel) occurs just after the medium (e.g., radio channel) becomes free, following a busy medium. This highest probability of a collision results from the presence of multiple devices that are waiting for the medium to become available again. Therefore, the exemplary embodiments employ a random re-transmission back-off mechanism to resolve medium contention conflicts.

Control logic 205 employs a random back-off procedure once the channel in-use sensing mechanism detects a close proximity transmission so that RFID device 200 does not repetitively try to seize the channel in a deterministic manner. Thus, RFID device 200 remains energized from the induced signal received from its reader (not shown in FIG. 2), but does not transmit data until a back-off timer of control logic 205 has reached a threshold value. However, the threshold value for the back-off timer might change randomly, or the back-off counter might start at a random value, to maintain random re-transmission attempts.

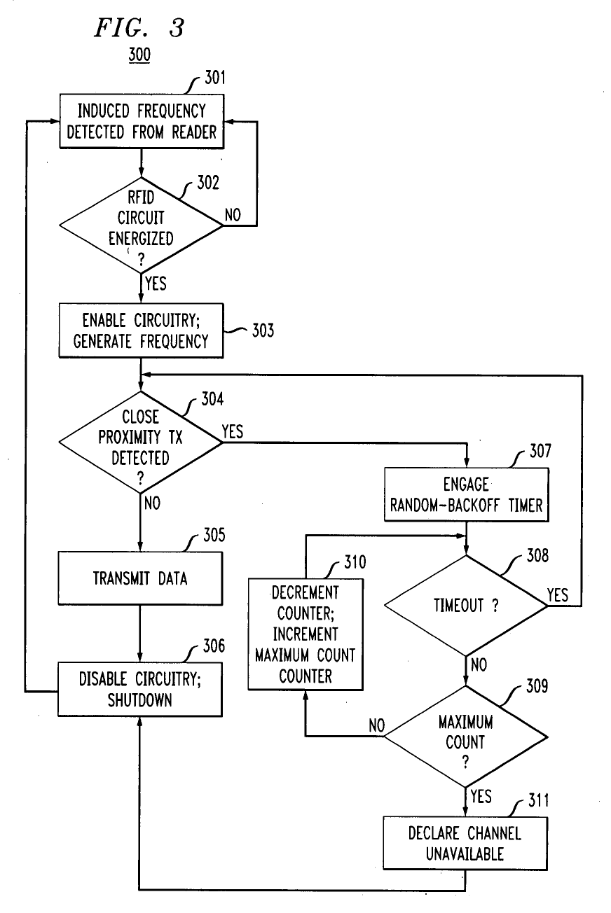

FIG. 3 shows an exemplary method as might be employed by the RFID device of FIG. 2. At step 301, the RFID device detects an induced carrier frequency. At step 302, a test determines whether the induced carrier frequency is from its associated reader. If the test of step 302 determines that the induced carrier frequency is not from its associated reader, the method returns to step 301. If the test of step 302 determines that the induced carrier frequency is from its associated reader, the method advances to step 303.

At step 303, circuitry of the RFID device is enabled, including circuitry that generates the transmit frequency carrier for the RFID device. At step 304, a test determines whether the channel in-use sensing mechanism of the CUSC has detected a close proximity transmission of one or more other RFID devices. If the test of step 304 determines that the channel in-use sensing mechanism of the CUSC has not detected a close proximity transmission, the method advances to step 305. At step 305, the RFID device transmits its data. From step 305, the method advances to step 306 to disable its circuitry enabled at step 303 to shut the RFID device down (“shutdown”). The method then returns to step 301 from step 306.

If the test of step 304 determines that the channel in-use sensing mechanism of the CUSC has detected a close proximity transmission, the method advances to step 307. At step 307, a random back-off timer is engaged, such as by enabling a count-down counter. At step 308, a test determines whether the random back-off timer has expired, indicating a timeout. If the test of step 308 determines that the timer has expired and a timeout has occurred, then the method advances to step 304 where, if no other close proximity transmission is detected, the method will advance to step 305 to transmit data. If the test of step 308 determines that the timer has not expired, the method advances to step 309.

At step 309, a test determines whether a maximum count is reached, indicating that a maximum number of attempts to access the channel has occurred (such limit might be reached, for example, because the received energy powering tile RFID device has dissipated or is too low to allow for successful data transmission). If the test of step 309 determines that the maximum count is not reached, the method decrements the counter of the random back-off timer and increments the maximum count counter at step 310, and then returns to step 308. If the test of step 309 determines that a maximum count has occurred, then, at step 311, the method declares that the channel is unavailable for transmission of data and advances to step 306 to shutdown.

Methods exist in the art to provide more sophisticated random back-off procedures than might be implemented using a simple back-off timer. For example, U.S. Pat. No. 7,046,649 to Awater et al., issued May 16, 2006, which is incorporated herein in its entirety by reference, teaches coexistence of a Bluetooth radio system and an IEEE 802.11 radio system within the same user device. The 802.11 basic medium access behavior allows interoperability between compatible physical layer protocols through the use of the CSMA/CA (carrier sense multiple access with a collision avoidance) protocol and a random back-off time following a busy medium condition. In addition all directed traffic uses immediate positive acknowledgement (ACK frame), where a retransmission is scheduled by the sender if no positive acknowledgement is received. The 802.11 CSMA/CA protocol is designed to reduce the collision probability between multiple stations accessing the medium at the point in time where collisions are most likely occur. In addition, the 802.11 MAC defines: special functional behavior for fragmentation of packets; medium reservation via RTS/CTS (request-to-send/clear-to-send) polling interaction; and point co-ordination (for time-bounded services).

An RFID system in general consists of four essential system components: The RFID transceiver (e.g., transmit modulator and receive demodulator), a wireless infrastructure, readers/senders, and a host system interface (e.g., a reader) that includes a data validation process. Embodiments of the present invention described herein might preferably be employed within the RFID device or transceiver located in, for example, a card or document in the possession of the end-user. However, the present invention is not so limited, and some aspects of tile present invention might be coordinated by circuitry within the reader and/or host system interface.

Embodiments of the present invention might provide for the following advantages. Reduced performance from interference in communication caused by simultaneous activation of multiple RFID transceiver devices might be reduced or avoided. Unintended invocation of the self destruct mechanism in the RFID device cards from numerous unsuccessful transmissions due to system radio access collisions of the close proximity devices rather than by an attack by hackers might also be reduced or avoided.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The present invention may be implemented as circuit-based processes, including possible implementation as a single integrated circuit (such as an ASIC or an FPGA), a multi-chip module, or a single card. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Signals and corresponding nodes or ports may be referred to by the same name and are interchangeable for purposes here.

We claim:

1. A method of data transmission by an energized radio-frequency identification (RFID device), the method comprising the steps of:
(a) detecting whether a radio channel is busy with a transmission of one or more close proximity RFID devices; and,
if the radio channel is busy,
(b) delaying transmission of data by the energized RFID device.

2. The invention of claim 1, further comprising the step of transmitting the data if the radio channel is not busy.

3. The invention of claim 1 further comprising the step of determining whether the RFID device is energized by an associated reader and, if the RFID device is not energized by an associated reader, shutting down the RFID device.

4. The invention of claim 1, wherein step (b) comprises the steps of:
(b1) engaging a timer if the radio channel is busy;
(b2) testing whether the timer is expired; and
(b3) repeating step (a) if the timer is expired.

5. The invention of claim 4, further comprising the step of determining if a maximum count number is reached for attempts to transmit data and, if the maximum count number is reached, shutting down the RFID device.

6. The invention of claim 4, further comprising the step of transmitting the data if step (b3) determines the radio channel is not busy.

7. The invention of claim 4, wherein, for steps (b1), (b2), and (b3), the timer is a random back-off timer.

8. The invention of claim 1, wherein step (a) detects signal energy within a portion of a frequency band of operation of the RFID device, the portion overlapping at least one portion of a frequency band of operation of another RFID device.

9. The invention of claim 1, wherein the method is embodied as steps implemented in a processor of an integrated circuit.

10. Apparatus for data transmission by an energized radio-frequency identification (RFID device), the apparatus comprising:
a channel-use sensing circuit adapted to detect whether a radio channel is busy with a transmission of one or more close proximity RFID devices;
control logic adapted to, if the radio channel is busy, delay transmission of data by the energized RFID device.

11. The invention of claim 1, further comprising a transmitter configured to transmit the data if the radio channel is not busy.

12. The invention of claim 10, wherein the control logic is configured to determine whether the RFID device is energized by an associated reader and, if the RFID device is not energized by an associated reader, to shut down the RFID device.

13. The invention of claim 10, wherein the control logic comprises a timer, and the control logic is further configured to:
engage a timer if the radio channel is busy, and
test whether the timer is expired; and
if the timer is expired, channel-use sensing circuit detects whether the radio channel is still busy.

14. The invention of claim 13, further comprising the step of determining if a maximum count number is reached for attempts to transmit data and, if the maximum count number is reached, shutting down the RFID device.

15. The invention of claim 13, further comprising a transmitter configured to transmit the data if the channel-use sensing circuit detects the radio channel is not busy.

16. The invention of claim 13, wherein the timer is a random back-off timer.

17. The invention of claim 10, wherein channel-use sensing circuit detects signal energy within a portion of a frequency band of operation of the RFID device, the portion overlapping at least one portion of a frequency band of operation of another RFID device.

18. The invention of claim 10, wherein the apparatus is embodied in at least one of a proximity device and a vicinity device.

19. The invention of claim 10, wherein the apparatus is embodied in an integrated circuit.
